(19) United States
(12) Patent Application Publication
(10) Pub. No.: US 2017/0228582 A1
(43) Pub. Date: Aug. 10, 2017

(54) FINGERPRINT AUTHENTICATION DISPLAY DEVICE AND AUTHENTICATION DISPLAY METHOD

(71) Applicant: Boe Technology Group Co., Ltd., Beijing (CN)

(72) Inventor: Xin Li, Beijing (CN)

(73) Assignee: Boe Technology Group Co., Ltd., Beijing (CN)

(21) Appl. No.: 15/518,547

(22) PCT Filed: Dec. 29, 2015
(86) PCT No.: PCT/CN2015/099363

§ 371 Date: Apr. 12, 2017

(30) Foreign Application Priority Data
Aug. 21, 2015 (CN) 201410518494.7

(51) Int. Cl. G06K 9/00; G06F 3/0488; G06F 21/32

(52) U.S. Cl. CPC G06K 9/00114; G06F 21/32; G06K 9/00093; G06F 3/0488; G06F 17/30

(57) ABSTRACT

The present disclosure relates to the field of display technology, and discloses a fingerprint authentication display device and method. The fingerprint authentication display device comprises a fingerprint storage unit configured to store the fingerprints of a plurality of authorized users; a user configuration storage unit configured to record user configuration parameters of each authorized user; a fingerprint identifier configured to collect fingerprints and identify the fingerprint information of the authorized user, and send the collected fingerprint to the display unit if the collected fingerprint is the fingerprint of the authorized user; a display unit connected to the user configuration storage unit and configured to read user configuration parameters corresponding to the collected fingerprint and display an image based on the user configuration parameters. The fingerprint authentication display device and authentication display method realize multiple-user verification of a display device by means of fingerprint identification, as well as user customized interface display.

### RELATED APPLICATIONS

The present application is the U.S. national phase entry of PCT/CN2015/099363, with an international filling date of Dec. 29, 2015, which claims the benefit of Chinese Patent Application No. 201510518494.7, filed on Aug. 21, 2015, the entire disclosure of which is incorporated herein by reference.

### TECHNICAL FIELD

The present disclosure relates to the field of display technology, and more particularly to a fingerprint authentication display device and authentication display method.

### BACKGROUND

In a prior-art fingerprint identification display device, fingerprint identification only plays a role of an apparatus switch and merely enhances the confidentiality of the display device, which is a simple application. At present, the combination of fingerprint identification and display technologies is unable to realize multiple-user verification.

### SUMMARY

To overcome the defect of the prior-art fingerprint identification display device, it is desirable to realize multiple-user verification of a display device by means of fingerprint identification, as well as user customized interface display.

To this end, there is provided a fingerprint authentication display device according to one aspect. The fingerprint authentication display device comprises a fingerprint storage unit, a user configuration storage unit, a fingerprint identifier and a display unit. The fingerprint storage unit is configured to store the fingerprints of a plurality of authorized users. The user configuration storage unit is configured to record user configuration parameters of each authorized user. The fingerprint identifier is connected to the fingerprint storage unit and the display unit and configured to collect fingerprints in real time and verify the collected fingerprints. The fingerprint identifier is configured to send the collected fingerprint to the display unit if the collected fingerprint is verified as being matchable with the fingerprint of the authorized user stored in the fingerprint storage unit. The display unit is connected to the user configuration storage unit, and configured to read user configuration parameters corresponding to the collected fingerprint and display an image based on the user configuration parameters.

In certain exemplary embodiments, the fingerprint identifier comprises a fingerprint collection unit configured to collect fingerprints; a fingerprint verification unit connected to the fingerprint collection unit, the fingerprint storage unit and the display unit and configured to compare and verify the collected fingerprint with the fingerprints of the authorized users stored in the fingerprint storage unit and send the collected fingerprint that has been verified to the display unit.

In certain exemplary embodiments, the fingerprint authentication display device further comprises a use state storage unit connected to the fingerprint identifier. When a previous user is in a use state, the fingerprint identifier collects the fingerprint of a subsequent user and triggers the use state storage unit after verification of the fingerprint. The use state storage unit is configured to store the use state of the previous user based on the triggering of the fingerprint identifier.

In certain exemplary embodiments, the use state comprises running states of a front-end interface and background programs.

In certain exemplary embodiments, the fingerprint authentication display device further comprises a user authorization unit connected to the fingerprint storage unit, the user configuration storage unit, the fingerprint identifier and the display unit. The user authorization unit is configured to trigger the fingerprint identifier to collect fingerprints, store the collected fingerprints to the fingerprint storage unit, receive the configuration parameters inputted by a user and store the configuration parameters to the user configuration storage unit.

In certain exemplary embodiments, the user configuration parameters comprises display parameters. The display parameters may comprise at least one of brightness, contrast, font size, wallpaper and voice.

In certain exemplary embodiments, the user configuration parameters comprises at least one of application configuration in the display device, touch-control mode configuration and privacy file display configuration.

In certain exemplary embodiments, the application configuration in the display device comprises applications displayed on a display unit interface, application account password and parameter settings.

According to another aspect, there is also provided a fingerprint authentication display method. The fingerprint authentication display method comprises the steps of:

collecting a fingerprint;

comparing and verifying the collected fingerprint with the fingerprints of a plurality of authorized users stored beforehand;

after verification of the collected fingerprint, reading user configuration parameters of a user corresponding to the collected fingerprint and displaying an image based on the user configuration parameters.

In certain exemplary embodiments, the fingerprint authentication display method further comprises the step of, before the verifying, authorizing a user:

collecting and storing a fingerprint of a user to be authorized;

receiving and storing configuration parameters inputted by the user to be authorized so as to authorize the user to be authorized.

In certain exemplary embodiments, when a previous user is in a use state, the fingerprint authentication display method further comprises the step of storing the use state of the previous user after verifying the fingerprint of a subsequent user and before displaying the image corresponding to the subsequent user.

In certain exemplary embodiments, the use state comprises running states of a front-end interface and background programs.

In certain exemplary embodiments, the user configuration parameters may comprise display parameters. The display parameters comprises at least one of brightness, contrast, font size, wallpaper and voice.

In certain exemplary embodiments, the user configuration parameters comprises at least one of application configuration in the display device, touch-control mode configuration and privacy file display configuration.

In certain exemplary embodiments, the application configuration in the display device comprises applications displayed on a display unit interface, application account password and parameter settings.

The fingerprint authentication display device and authentication display method as described herein can verify whether the collected fingerprint belongs to the authorized user when different users are using the device by way of storing the fingerprints of a plurality of authorized users beforehand, thereby realizing multi-user verification of the display device through fingerprint identification.

### BRIEF DESCRIPTION OF DRAWINGS

To explain the technical solutions in the embodiments of the present disclosure more clearly, the drawings necessary for describing the embodiments will be briefly introduced below. It should be realized that the following drawings are only related to some embodiments. Those skilled in the art can obtain other drawings based on these drawings without making inventive effort.

FIG. 1 is a structural schematic view of a fingerprint authentication display device according to an embodiment;

FIG. 2 is a structural schematic view of another fingerprint authentication display device according to another embodiment;

FIG. 3 is a structural schematic view of a yet fingerprint authentication display device according to a yet embodiment; and

FIG. 4 is a flowchart of a fingerprint authentication display method according to an embodiment;

### DETAILED DESCRIPTION

To assist those skilled in the art in better understanding the object, technical solutions and advantages of the present disclosure, the implementations of the present disclosure will be further described in detail with reference to the drawings and embodiments. The following embodiments are used to explain the present invention, rather than limit the scope of the present invention.

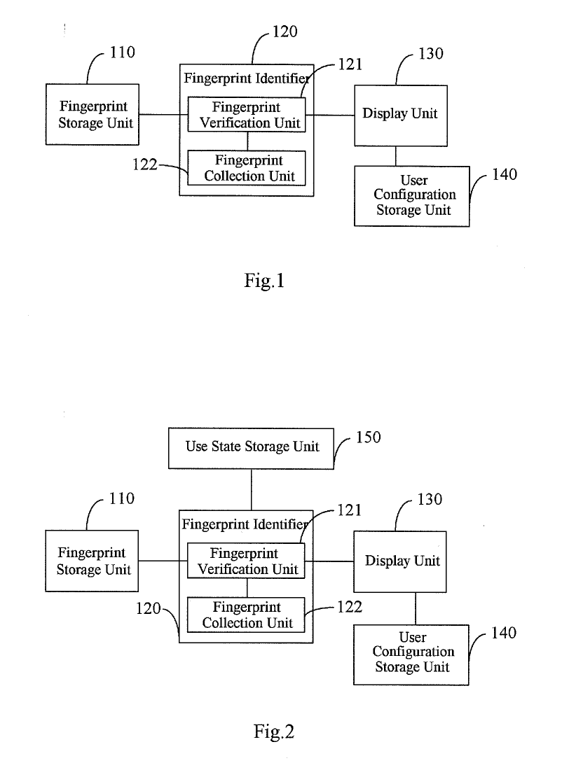

A fingerprint authentication display device according to an embodiment, as shown in FIG. 1, comprises a fingerprint storage unit 110, a fingerprint identifier 120, a display unit 130 and a user configuration storage unit 140.

The fingerprint storage unit 110 is configured to store the fingerprints of a plurality of authorized users.

The user configuration storage unit 140 is configured to record user configuration parameters of each authorized user.

The fingerprint identifier 120 is connected to the fingerprint storage unit 110 and the display unit 130 and configured to collect fingerprints in real time and verify the collected fingerprints. The fingerprint identifier 120 is also configured to send the collected fingerprint to the display unit 130 if the collected fingerprint is verified as being matchable with the fingerprint of the authorized user stored in the fingerprint storage unit 110.

The display unit 130 is connected to the user configuration storage unit 140, and configured to read user configuration parameters corresponding to the collected fingerprint and display an image based on the user configuration parameters.

When a user B wants to use the display device, he/she can be authenticated through fingerprint identification. The display device may be under a screen-locking state or a state of being used by a user A. The fingerprint identifier 120 collects the fingerprint of the user B and then compares and verifies the same with the fingerprints stored in the fingerprint storage unit 110. If the fingerprint of the user B is matchable with one of the fingerprints, it means that the user B is an authorized user. The fingerprint identifier 120 sends the fingerprint of the user B to the display unit 130. The display unit 130 reads the user configuration parameters of the user B from the user configuration storage unit 140 and displays an image based on the user configuration parameters of the user B.

As stated above, the fingerprint authentication display device according to an embodiment stores the fingerprints of a plurality of authorized users beforehand and verifies whether the collected fingerprints belong to the authorized users when different users are using the display device. If the user is verified as the authorized user, an image is displayed based on the configuration parameters of the authorized user, which not only realizes the multi-user verification, but also takes account of customized settings of each user, thereby improving user experience.

In an embodiment, the fingerprint identifier 120 may comprise a fingerprint collection unit 122 configured to collect fingerprints. The fingerprint identifier 120 may also comprise a fingerprint verification unit 121 connected to the fingerprint collection unit 122, the fingerprint storage unit 110 and the display unit 130 and configured to compare and verify the collected fingerprint with the fingerprints of the authorized users stored in the fingerprint storage unit 130. If the collected fingerprint matches one of the fingerprints, it passes verification and the display unit 130 is triggered to display after the verification.

In a use scenario, when a user wants to use the display device, a previous user is still using it (namely, the user does not operate the display device, and the display device does not lock the screen). In such a use scenario, as shown in FIG. 2, the fingerprint authentication display device according to an embodiment further comprises a use state storage unit 150 connected to the fingerprint identifier 120. The fingerprint identifier 120 collects the fingerprint and triggers the use state storage unit 150 after verification of the collected fingerprint. The use state storage unit 150 is configured to store the use state of the previous user after being triggered by the fingerprint identifier 120. The use state may comprise running states of a front-end interface and background programs. For instance, after the user B passes verification and before the interface of the user B is displayed, the display device stores the current use state of the user A, which comprises running states of the front-end interface and background programs, so that the user A will directly enter into the previous state before the next use.

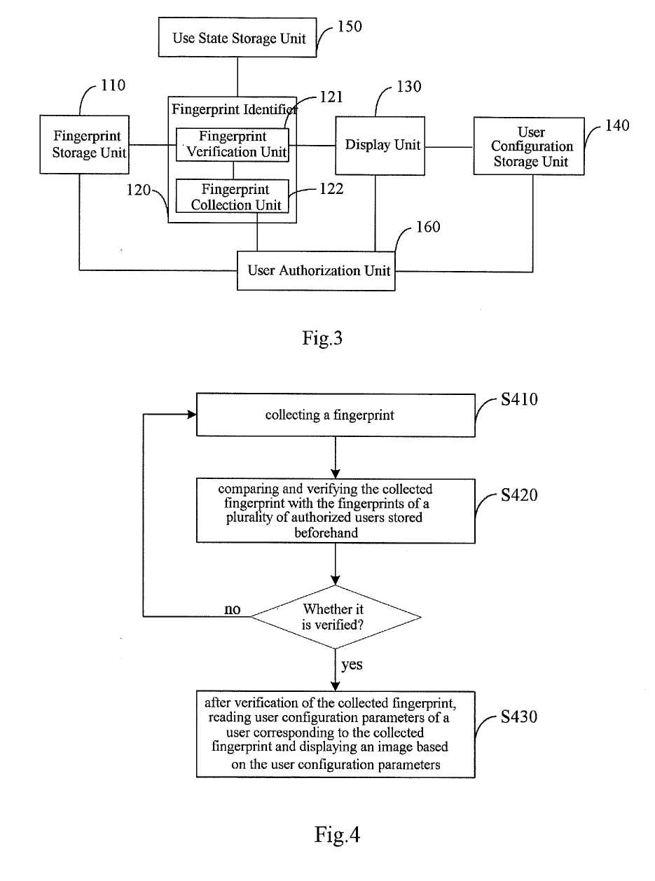

Information respectively stored in the fingerprint storage unit 110 and the user configuration storage unit 140 can enable the display device to be connected to a superior computer so as to enroll the fingerprints of the authorized users and store the user configuration parameters in advance. According to an embodiment, there is also provided a fingerprint authentication display device which provides user authorization with no need of getting connected to a superior computer. As shown in FIG. 3, the fingerprint authentication display device further comprises a user authorization unit 160 connected to the fingerprint storage unit 110, the user configuration storage unit 140, the fingerprint identifier 120 and the display unit 130. The user authorization unit 160 is configured to trigger the fingerprint identifier 120 to collect fingerprints, store the collected fingerprints to the fingerprint storage unit 110, receive the configuration parameters inputted by a user (who can input parameters by the touch-sensitive display screen of the display unit 130) and store the configuration parameters to the user configuration storage unit 140.

The user configuration parameters may comprise display parameters. The display parameters may comprise at least one of brightness, contrast, font size, wallpaper and voice. The user A and the user B can set the respective display parameters according to their own preference. For instance, the user A may set the brightness as lower for the sake of energy saving. The user B prefers a brighter screen and may set the brightness as higher.

The user configuration parameters may also comprise at least one of application configuration in the display device, touch-control mode configuration and privacy file display configuration. In a specific implementation, the application configuration in the display device may comprise: applications displayed on a display unit interface, application account password and parameter settings. For instance, the user A likes to watch videos on Youku, so the user A sets the video application displayed on the display interface as Youku APP. The user B prefers iQIYI, so the user B sets the video application displayed on the display interface as iQIYI APP. When reading a novel, the user A likes to flip pages by way of such a touch-control mode as sliding to the left or right, so the gesture of sliding to the left or right is set for page flipping. The user B prefers such a touch-control mode as up-down scroll for page turning, so the gesture of scrolling upwards or downwards can be set for that purpose. The privacy file display configuration may comprise different users' privacy settings for photographs, documents and payment APPs, etc., which means other uses are prohibited from having access to such files.

The fingerprint authentication display device may be a smart mobile phone, a smart watch, a tablet and a laptop, etc. The fingerprint storage unit 110 and the user configuration storage unit 140 may be memories in those devices. The display unit 130 comprises a display screen. The use state storage unit 150 and the user authorization unit 160 may be processing components (such as processors or specialized functional units of those devices) for curing corresponding processing programs.

According to another aspect, there is also provided a fingerprint authentication display method. As shown in FIG. 4, the fingerprint authentication display method comprises the steps of:

Step S410: collecting a fingerprint;

Step S420: comparing and verifying the collected fingerprint with the fingerprints of a plurality of authorized users stored beforehand;

Step S430: after verification of the collected fingerprint, reading user configuration parameters of a user corresponding to the collected fingerprint and displaying an image based on the user configuration parameters.

The fingerprint authentication display method stores the fingerprints of a plurality of authorized users beforehand and verifies whether the collected fingerprints belong to the authorized users when different users are using the display device. If the user is verified as the authorized user, an image is displayed based on the configuration parameters of the authorized user, which not only realizes the multi-user verification, but also takes account of customized settings of each user, thereby improving user experience.

In an embodiment, the fingerprint authentication display method further comprises the step of, before the verifying, authorizing a user, which includes

collecting and storing a fingerprint of a user to be authorized; and

receiving and storing configuration parameters inputted by the user to be authorized so as to authorize the user to be authorized.

In an embodiment, when a previous user is in a use state, the fingerprint authentication display method further comprises the step of storing the use state of the previous user after verifying the fingerprint of a subsequent user and before displaying the image corresponding to the subsequent user. The use state may comprise running states of a front-end interface and background programs.

In an embodiment, the user configuration parameters may comprise display parameters. The display parameters may comprise at least one of brightness, contrast, font size, wallpaper and voice.

In an embodiment, the user configuration parameters may comprise at least one of application configuration in the display device, touch-control mode configuration and privacy file display configuration.

To be specific, the application configuration in the display device may comprise applications displayed on a display unit interface, application account password and parameter settings.

The method according to the embodiment can be implemented by the aforementioned fingerprint authentication display device.

Those ordinarily skilled in the art should understand that various aspects or possible implementations thereof can be specifically implemented as systems, methods or computer program products. Thus, the various aspects or possible implementations thereof may be in the form of a full hardware embodiment, a full software embodiment (including firmware, resident software and the like), or an embodiment combining software and hardware, which are collectively called herein as “circuits”, “modules”, “units” or “systems”. In addition, the various aspects or possible implementations thereof may be in the form of computer program products, which comprise computer readable program codes stored in a computer (or other smart mobile device) readable medium.

Computer readable media may be computer readable signal media or computer readable storage media. The computer readable storage media comprise, but are not limited to, electronic, magnetic, optical, electromagnetic, infrared or semi-conductive storage systems, devices or apparatuses, or any suitable combination thereof. For instance, the computer readable storage media may comprise random access memory (RAM), read-only memory (ROM), erasable programmable read-only memory (EPROM), flash memory, fiber optic memory and portable read-only memory (CD-ROM).

A processor in a computer reads computer readable program codes stored in computer readable media, such that the processor can carry out functional actions required in each step or a combination of various steps in the flowchart, and realize devices for carrying out the functional actions required in each block or a combination of various blocks in the block diagram.

The computer readable program codes can be completely or partially executed in a user's computer, or executed as a separate software package, or executed partially in a user's computer and partially in a remote computer, or executed completely in a remote computer or server. It shall also be noted that in some alternative solutions, the steps in the flowchart or functions indicated in the blocks of the block diagram may not be carried out in the order as indicated therein. For instance, according to the function involved, two steps or two blocks shown successively may, in fact, be carried out substantially at the same time, or these blocks may sometimes be carried out in a reverse order.

What needs to be explained is that the above embodiments are only illustrated by way of the individual function modules division. In actual application, the above functions can be allocated to different functional modules as desired. The internal structure of the device can be divided into different functional modules so as to accomplish all or part of the functions as stated above. In addition, function(s) of the above one module can be achieved by a plurality of modules, and functions of the plurality of modules can be integrated into one module.

The above embodiments are only used to explain, rather than limit, the present invention. Those skilled in the art can make various modifications and variations of the embodiments without departing from the spirit and scope of the present invention. All equivalent technical solutions will fall within the scope of the present application. The protection scope of the present invention shall depend on the appended claims.

In the claims, any reference sign in parentheses should not be interpreted as a limitation to the claims. The term “comprise/include” does not exclude the presence of elements or steps other than those listed in the claims. The word “a” or “an” in front of elements do not exclude the presence of a plurality of such elements.

In device or system claims that enumerate several means, one or more of the means can be embodied in one and the same item of hardware. The mere fact that some measures are recited in different dependent claims does not indicate that the combination of the measures cannot be used to advantage.

1. A fingerprint authentication display device comprising: a fingerprint storage unit, a user configuration storage unit, a fingerprint identifier and a display unit,
wherein the fingerprint storage unit is configured to store the fingerprints of a plurality of authorized users;
the user configuration storage unit is configured to record user configuration parameters of each authorized user;
the fingerprint identifier is connected to the fingerprint storage unit and the display unit and configured to collect fingerprints in real time and verify the collected fingerprints; and configured to send the collected fingerprint to the display unit if the collected fingerprint is verified as being matchable with the fingerprint of the authorized user stored in the fingerprint storage unit;
the display unit is connected to the user configuration storage unit and configured to read user configuration parameters corresponding to the collected fingerprint and display an image based on the user configuration parameters.

2. The fingerprint authentication display device according to claim 1, wherein the fingerprint identifier comprises:
a fingerprint collection unit configured to collect fingerprints; and
a fingerprint verification unit connected to the fingerprint collection unit, the fingerprint storage unit and the display unit and configured to compare and verify the collected fingerprint with the fingerprints of the authorized users stored in the fingerprint storage unit and send the collected fingerprint that has been verified to the display unit.

3. The fingerprint authentication display device according to claim 1, further comprising a use state storage unit connected to the fingerprint identifier; when a previous user is in a use state, the fingerprint identifier collects the fingerprint of a subsequent user and triggers the use state storage unit after verification of the fingerprint; and the use state storage unit is configured to store the use state of the previous user based on the triggering of the fingerprint identifier.

4. The fingerprint authentication display device according to claim 3, wherein the use state comprises running states of a front-end interface and background programs.

5. The fingerprint authentication display device according to claim 1, further comprising a user authorization unit connected to the fingerprint storage unit, the user configuration storage unit, the fingerprint identifier and the display unit and configured to trigger the fingerprint identifier to collect fingerprints, store the collected fingerprints to the fingerprint storage unit, receive the configuration parameters inputted by a user and store the configuration parameters to the user configuration storage unit.

6. The fingerprint authentication display device according to claim 1, wherein the user configuration parameters comprise display parameters that comprise at least one of brightness, contrast, font size, wallpaper and voice.

7. The fingerprint authentication display device according to claim 1, wherein the user configuration parameters comprise at least one of application configuration in the display device, touch-control mode configuration and privacy file display configuration.

8. The fingerprint authentication display device according to claim 7, wherein the application configuration in the display device comprises applications displayed on a display unit interface, application account password and parameter settings.

9. A fingerprint authentication display method, comprising the steps of:
collecting a fingerprint;
comparing and verifying the collected fingerprint with the fingerprints of a plurality of authorized users stored beforehand;
after verification of the collected fingerprint, reading user configuration parameters of a user corresponding to the collected fingerprint and displaying an image based on the user configuration parameters.

10. The fingerprint authentication display method according to claim 9, further comprising the step of, before the verifying, authorizing a user:
collecting and storing a fingerprint of a user to be authorized;
receiving and storing configuration parameters inputted by the user to be authorized so as to authorize the user to be authorized.

11. The fingerprint authentication display method according to claim 9, wherein when a previous user is in a use state, the method further comprises the step of storing the use state of the previous user after verifying the fingerprint of a subsequent user and before displaying the image corresponding to the subsequent user.

12. The fingerprint authentication display method according to claim 11, wherein the use state comprises running states of a front-end interface and background programs.

13. The fingerprint authentication display method according to claim 9, wherein the user configuration parameters comprise display parameters that comprise at least one of brightness, contrast, font size, wallpaper and voice.

14. The fingerprint authentication display method according to claim 9, wherein the user configuration parameters comprise at least one of application configuration in the display device, touch-control mode configuration and privacy file display configuration.

15. The fingerprint authentication display method according to claim 14, wherein the application configuration in the display device comprises applications displayed on a display unit interface, application account password and parameter settings.
